(19) United States
(12) Patent Application Publication
(10) Pub. No.: US 2008/0157534 A1
(43) Pub. Date: Jul. 3, 2008

(54) ZERO POLLUTION PROCESS AND FACILITY FOR GENERATING ELECTRICAL ENERGY

(76) Inventors: Eddie K. Wilson, Sr., Memphis, TN (US); Linda D. Studdard, Ocean Springs, MS (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/617,412

(22) Filed: Dec. 28, 2006

(51) Int. Cl. H02K 7/18; H02K 7/02; H02K 7/06

(52) U.S. Cl. 290/1 R; 322/4; 322/13

(57) ABSTRACT

An oscillating beam imparts rotation to a shaft that turns an electrical generator. The beam may be the walking beam of a pump jack, whereas the shaft may be part of a crank having a journal that is offset from the shaft, with one end of the beam being connected to the journal of the crank.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention relates in general to the production of electrical energy and more particularly to a facility and process for generating electrical energy.

Much of the electrical energy used by the United States and other countries, as well, derives from fossil fuels such as coal, oil and natural gas. But as the finite reserves of these fuels are consumed, the fuels become more difficult and expensive to extract, thus increasing the cost of producing electrical energy. Moreover, their use introduces carbon dioxide and, in the case of some fuels, significant pollutants into the atmosphere, creating harmful conditions such as smog and perhaps global warming. Other sources of electrical energy have their detractions as well. For example, hydroelectric projects usually include dams, which require huge capital expenditures and inundate land that could otherwise be put to productive purposes. Nuclear power plants are also costly and produce radioactive wastes, which must be disposed of safely. Wind-powered generators are unreliable, because they depend on winds that can vary in direction and magnitude, and furthermore they do not produce much power. Solar units are likewise deficient, because they require sun, which in many parts of the world shines infrequently, and furthermore such units produce only minimal energy.

The depletion of oil reserves has left many oil fields with unused pumping equipment. It simply remains idle, having no other useful purpose.

### BRIEF DESCRIPTION OF THE SEVERAL VIEWS OF THE DRAWINGS

FIG. 1 is a plan view of an electrical generating unit constructed in accordance with and embodying the present invention;

FIG. 2 is a sectional view of the generating unit taken along line 2-2 of FIG. 1 and showing the prime mover and main crank of the unit;

FIG. 3 is a plan view of a modified generating unit; and

FIG. 4 is a sectional view of the modified generating unit taken along line 4-4 of FIG. 3.

### DESCRIPTION OF THE PREFERRED EMBODIMENT

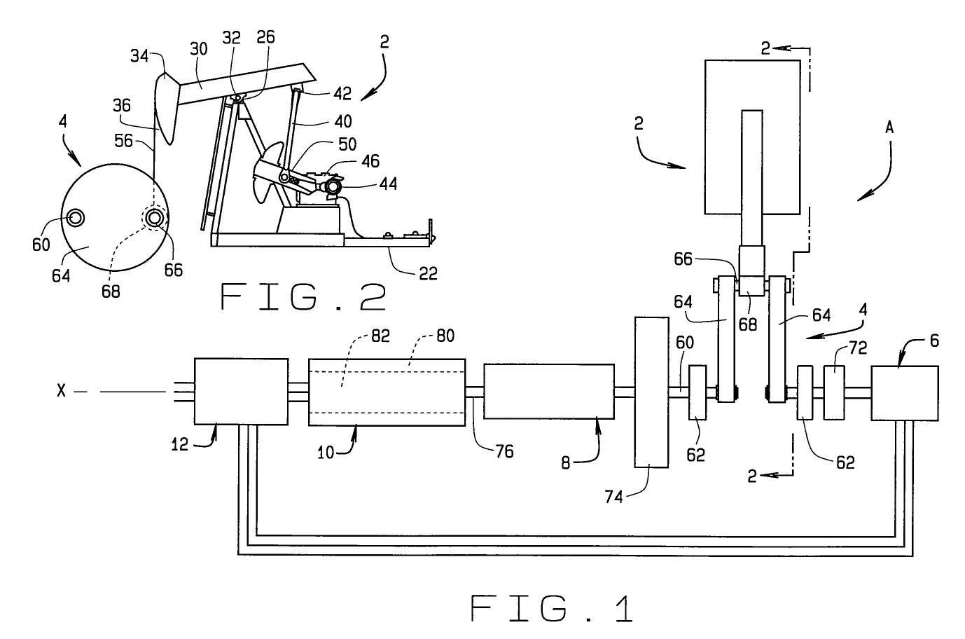

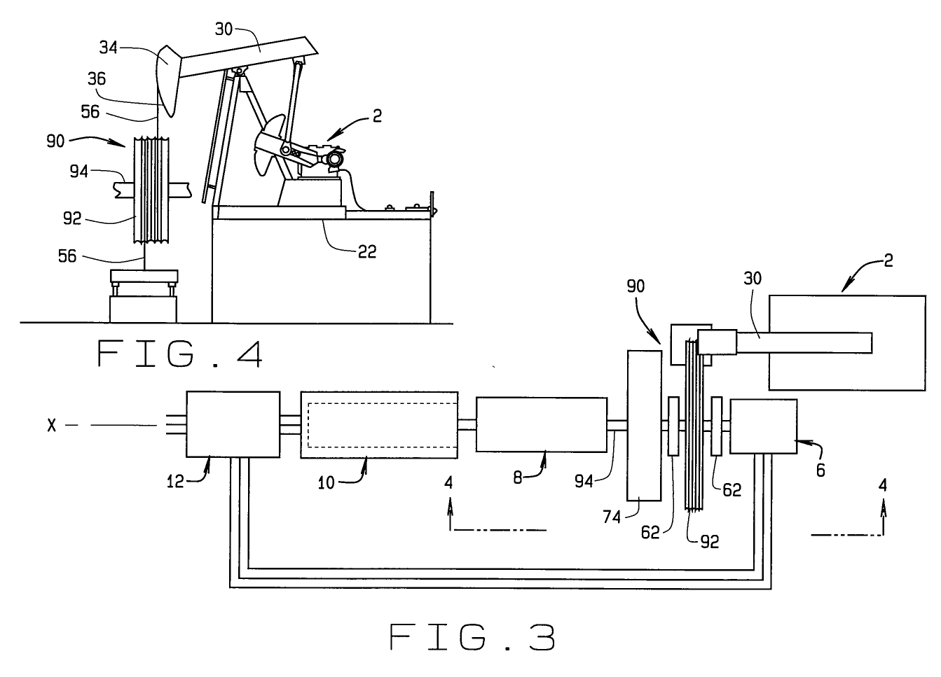

Referring to the drawings, a generating unit A (FIGS. 1 and 2) produces electrical energy for supply to an electrical grid or for use in some other capacity. The unit A may be combined with other units A, with one of the units A supplying electrical energy for operating the other units A. Each unit A includes a prime mover 2, a main crank 4, an auxiliary motor 6, a speed increaser 8, an electrical generator 10, and a control center 12. The main crank rotates about a main axis X. The unit A can be of varying size for the prime mover 2 and for the generator 10, depending on site requirements.

The prime mover 2 is in essence a pumping unit of the type used to extract oil from oil wells, but instead of imparting a reciprocating motion to a pump rod, it imparts a rotary motion to the main crank 4. Any of several varieties of pumping units—or so-called “pump jacks”—will suffice, the conventional crank balanced pumping unit being one example. As such, the prime mover 2 of unit A includes a frame 22 that rests on a foundation and includes a post 24 that projects upwardly. At its upper end the post 24 is fitted with bearings 26 that are located along a transverse axis.

The post 24 supports a walking beam 30 having between its ends trunnions 32 that project laterally and are received in the bearings 26. The arrangement is such that the beam 30 can pivot in an oscillatory manner about the common axis of the bearings 26 and the trunnions 32. That axis lies parallel to the main axis X. At one end, the walking beam 30 is fitted with a head 34, often referred to as a “horsehead”, provided with an arcuate surface 36 that is convex and presented away from the trunnions 12. At its opposite end, the walking beam 30 is connected to connecting rods 40 at bearings 42.

The frame 32 of the drive unit B supports an electric motor 44 and nearby a gear reducer 46, with the two being connected by endless belts, or some other connecting devices, such that the gear reducer 46 is powered at a reduced velocity. The gear reducer 46 drives a crank arms 50 that rotate on it and are fitted with counterweights 52. The crank arms 50 at their ends are coupled to the connecting rods 40 that are in turn coupled to the walking beam 30 at the bearings 42.

When the motor 44 is energized, it rotates the crank arms 50 at a significantly slower velocity, but with a corresponding increase in torque. After all, the crank arms 50 are connected to the motor 44 through the gear reducer 46 and belts or other devices. The rotating crank arms 50, being connected to the walking beam 30 through the connecting rods 40, impart an oscillatory motion to the walking beam 30, with that motion being about the common axis of the bearings 26 and trunnions 32. The head 34 moves upwardly and downwardly. In doing so, it moves a flexible cable 56, which is attached to the head 34 at the upper end of the arcuate surface 36, upwardly and downwardly. The cable 56 extends over the arcuate surface 36 of the head 34.

The main crank 4 includes a shaft 60 that rotates in bearing 62 about a main axis X. The crank 4 also has two disks 64 that are spaced apart and parallel and near their peripheries are attached securely to the main shaft 60 so that the disks 64 interrupt the shaft 60. The disks 64 are joined together at a journal 66, which is likewise coupled to the disks 64 near their peripheries, although 180° from the shaft 60. Thus, the disks 64 serve as crank arms. The journal 66 supports a collar 68 that fits around it, yet can rotate on it, and the collar 68 is in turn connected to the cable 56 that extends upwardly to the head 34 on the walking bean 50 of the prime mover 2.

The shaft 60 of the main crank 4 beyond one of the disks 64 is coupled to the auxiliary motor 6 through an electric clutch 72. The motor 6, which is electrically powered, has the capacity to produce high torque at variable speeds. When energized, the motor 6 rotates the main crank 4, causing its journal 66 to orbit about the axis X.

Beyond the other disk 64 the shaft 60 is fitted with a flywheel 74.

The shaft 60 is connected to the speed increaser 8 beyond the flywheel 74 and its has output shaft 76 that is coupled to the generator 10. As a consequence of gearing within the speed increaser 8, the output shaft 76 rotates at an angular velocity considerably greater than the angular velocity of the shaft 60 for the main crank 4.

The electrical generator 10 has a stator 80 and a rotor 82 that revolves in the stator 76. The output shaft 76 of the speed increase 8 is connected to and turns the rotor 82 at a velocity considerably greater than the velocity of the main crank 4. Electrical current flows through winding in the stator 80 and likewise through the control center 12, which serves to control voltage and regulate phase. The control center 12 may divert some of the electrical current to the auxiliary motor 6. The rest is delivered to an electrical grid.

To bring the unit A on line as a producer of electrical energy for the grid, or otherwise, the auxiliary motor 6 is energized with electrical energy from an outside source, such as the grid itself. The motor 6 rotates the main crank 4. At the same time the electric motor 44 of the prime mover 2 is placed across a source of electrical energy. It rotates the crank arm 50, which in turn imparts translation, upwardly and downwardly, to the connecting rods 40. Being connected to the rods 40, the walking bean 30 undergoes a rocking motion about the axis of its trunnions 32. The head 34 at the opposite end of the walking bean 30 moves upwardly and downwardly. So does the cable 56 that is attached to the head 34. Indeed, on the upstroke of the head 34 the cable 34, acting through the collar 68, lifts the journal 66 essentially from its lowermost position to its uppermost position. The torque resulting from the force applied to the journal 66 imparts rotation to the crank 4 about the axis X. To be sure, the torque exists for no more than 180° of rotation, but the flywheel 74, and if necessary, the auxiliary motor 6 keep the crank 4 rotating for the other 180° of rotation. During that interval, the head 34 on the walking bean 30 descends and the cable 56 with it.

A modified generating unit B, like the unit A, has a prime mover 2, an auxiliary motor 6, a speed increaser 8 and an electrical generator 10, as well as a control center 12, each of which corresponds to its counterpart in the unit A. However, in lieu of the main crank 4, the unit B has a sheave assembly 90 including a grooved sheave 92 and a shaft 94 that serves as an axle for the sheave 92. The shaft 94 rotates in the bearing 62 about the axis X and carries the flywheel 74. At its one end it is connected to the auxiliary motor 6 and at its other end to the speed increaser 8. The cable 56 assumes a greater length and is wound around the sheave 92. At one end it is attached to the head 34 on the walking beam 30 of the prime mover 2—indeed, at the upper end of the head 34 and descends from there over the arcuate surface 36. The other end is attached to an anchor 96 located below the sheave 92.

When the head 34 on the walking beam 30 is at the bottom of its stroke, the cable 56 that is attached to the head 34 is relaxed around the sheave 92. Then as the head 34 rises, the cable 56 tightens around the sheave 92 and imparts rotation to the sheave 92 and to the main shaft 94 on which it is mounted. Upon reaching the top of its stroke, the head 34 immediately begins to descend and the cable 56 begins to rewind around the sheave 92. However, the sheave 92 and main shaft 94 continue to rotate by reason of the momentum imparted by the fly wheel 74 and the additional torque delivered by the auxiliary motor 6. At the bottom of its stroke, the head 34 immediately begins to rise and the cable 56 enables the prime mover 2 to again impart torque to the sheave 92. The cycle repeats.

The prime mover 2 for either the unit A or the unit B may be based on other types of oil field pumping units, such as the type having a counterweight on its walking beam instead of on the crank or it may even be an air-balanced unit. Indeed, virtually any pumping unit can be utilized, including special application units, such as low profile units and/or portable trailer-mounted units. Suitable pumping units are sold by Lufkin Industries of Lufkin, Tex., and George Drehe of Midland, Tex. Suitable Lufkin pumping units for driving generating units are:

Conventional crank Balanced Units (including units having 20 foot strokes)

Mark II Unitorque Units

Air balanced Units

Reverse Mark Units

Churchill Bean balanced Units

Low Profile Units

Portable/Trailer Mount Units

American Units

1. A generating unit for producing electrical energy, said unit comprising:
a prime mover including a walking beam that oscillates about an axis that extends transverse to the beam and a motor for imparting oscillation to the beam;
a main crank having a shaft and a journal offset radially from the shaft, the journal being connected to one end of the walking beam for the prime mover, so that oscillation of the walking beam will impart torque to the shaft; and
an electrical generator driven by the shaft of the main crank, so that when the crank rotates the generator will produce electrical energy.

2. A generating unit according to claim 1 wherein the beam of the prime mover has at one of its ends a head provided with a convex surface, and the beam is connected to the journal of the main crank through a cable that passes over the convex surface of the head.

3. A generating unit according to claim 1 wherein the prime mover is a pump jack.

4. A generating unit according to claim 1 wherein the prime mover includes:
a frame having a post that extends upwardly and supports the beam;
a motor on the frame;
a crank arm supported on the frame and coupled to the motor such that the motor rotates the crank arm; and
and a connecting rod coupling the crank arm to the beam such that rotation of the crank arm imparts a rocking motion to the beam.

5. A generating unit according to claim 4 wherein the beam at one of its ends has a head provided with a convex surface, and the journal of the main crank is connected to the beam through a cable that passes over the convex surface.

6. A generating unity according to claim 1 and further comprising an electrical motor coupled to the shaft of the main crank.

7. A generating unit according to claim 1 and further comprising a flywheel on the shaft of the main crank.

8. A generating unit according to claim 1 and further comprising a speed increaser interposed between the shaft of the main crank and the electrical generator.

9. A generating unit according to claim 1 wherein the axes of oscillation for the walking beam and the axes of the shaft for the main crank are parallel.

10. A process for generating electrical energy, said process comprising:
imparting oscillation to a beam;
with the oscillating beam applying torque to a shaft so that the shaft rotates; and
driving an electrical generator with the shaft.

11. A process according to claim 10 wherein the shaft is part of a crank and the oscillating beam is connected to the crank at a location offset from the axis of the shaft.

12. A process according to claim 10 wherein the torque is applied to the crank by the beam only in one direction of oscillation for the beam.

13. A process according to claim 11 wherein the crank has a shaft and a journal offset from the shaft, and the beam is connected to the crank at the journal.

14. A process according to claim 10 wherein the shaft carries a sheave and the beam is connected to the sheave through a cable that is attached to the end of the beam and winds around the sheave.

15. A generating unit for producing electrical energy, said unit comprising:
a prime mover including a walking beam that oscillates about an axis that extends transversely to the beam and a motor for imparting oscillation to the beam;
a shaft having a sheave;
a cable connecting one end of the walking beam with the sheave and being wound around the sheave, all such that the oscillation of the beam translates into rotation of the sheave and the shaft; and
an electrical generator driven by the shaft.
